(19) United States
(12) Patent Application Publication
(10) Pub. No.: US 2016/0129673 A1
(43) Pub. Date: May 12, 2016

(54) INTERMEDIATE FILM FOR LAMINATED GLASS, AND LAMINATED GLASS

(71) Applicant: SEKISUI CHEMICAL CO., LTD., Osaka (JP)

(72) Inventors: Keigo OOWASHI, Osaka (JP); Naoyuki NAGATANI, Osaka (JP); Ren-de SUN, Osaka (JP)

(73) Assignee: SEKISUI CHEMICAL CO., LTD., Osaka (JP)

(21) Appl. No.: 14/893,575

(22) PCT Filed: Aug. 29, 2014
(86) PCT No.: PCT/JP2014/072821

§ 371 Date: Nov. 24, 2015

(30) Foreign Application Priority Data
Aug. 30, 2013 (JP) 2013-180750

(51) Int. Cl. B32B 17/10

(52) U.S. Cl. CPC B32B 17/10477; B32B 17/10036; B32B 17/10761; B32B 17/10779; B32B 17/10633; B32B 2307/304; B32B 2264/102

(57) ABSTRACT

The present invention provides an interlayer film for laminated glass that can maintain excellent thermochromic properties for a long period of time and have appropriate adhesiveness to laminated glass components, and also a laminated glass including the interlayer film for laminated glass. The present invention relates to an interlayer film for laminated glass. The interlayer film includes a first resin layer containing a thermoplastic resin, a thermochromic layer, a second resin layer containing a thermoplastic resin. The layers are laminated in the stated order in the thickness direction. The thermochromic layer contains a thermoplastic resin and vanadium dioxide particles and has a water content of less than 0.4% by mass. Each of the first resin layer and the second resin layer has a water content that is higher than that of the thermochromic layer.

### TECHNICAL FIELD

The present invention relates to an interlayer film for laminated glass used for laminated glass for, for example, automobiles or buildings. In particular, the present invention relates to an interlayer film for laminated glass which can maintain excellent thermochromic properties for a long period of time and have appropriate adhesiveness to laminated glass components, and also a laminated glass including the interlayer film for laminated glass.

### BACKGROUND ART

Vanadium dioxide and substituted vanadium dioxide in which some of the vanadium atoms of the vanadium dioxide are substituted with other atoms are widely known to have thermochromic properties. These compounds undergo a phase transition from a semiconductor state to a metal state at or above a specific temperature, and show a great decrease in its infrared transmittance (Patent Literature 1, for example). Specifically, a vanadium dioxide film formed on glass, for example, has both a high visible light transmittance and a high infrared transmittance below the phase transition temperature, but exhibits a lower infrared transmittance with a high visible light transmittance at or above the phase transition temperature.

To date, several interlayer films for laminated glass utilizing the thermochromic properties of vanadium dioxide have been produced (Patent Literature 2, for example).

Finely dispersing vanadium dioxide particles in an interlayer film for laminated glass is expected to allow the interlayer film to have both a high visible light transmittance and a high infrared transmittance below the phase transition temperature of vanadium dioxide, and exhibit a lower infrared transmittance with a high visible light transmittance at or above the phase transition temperature.

### CITATION LIST

### Patent Literature

Patent Literature 1: JP 2000-233929 A

Patent Literature 2: JP 2004-346260 A

### SUMMARY OF INVENTION

### Technical Problem

However, in interlayer films for laminated glass with thermochromic properties, such as that of Patent Literature 2, the vanadium dioxide particles degrade due to moisture after a long period of use, causing a decrease in the thermochromic properties. This prevents conventional interlayer films for laminated glass, including the interlayer film of Patent Literature 2, from being used for a long period of time.

It is considered that decreasing the water content in the entire interlayer film for laminated glass can suppress the degradation of vanadium dioxide particles. However, low water contents in the interlayer film for laminated glass lead to an excessively high adhesiveness of the interlayer film to laminated glass components, which results in another problem of decreased shatterproof properties of the laminated glass.

An object of the present invention is to provide an interlayer film for laminated glass that can maintain excellent thermochromic properties for a long period of time and have appropriate adhesiveness to laminated glass components, and also a laminated glass including the interlayer film for laminated glass.

### Solution to Problem

One aspect of the present invention provides an interlayer film for laminated glass. The interlayer film includes a first resin layer containing a thermoplastic resin, a thermochromic layer, and a second resin layer containing a thermoplastic resin. The layers are laminated in the stated order in the thickness direction. The thermochromic layer contains a thermoplastic resin and vanadium dioxide particles and has a water content of less than 0.4% by mass. Each of the first resin layer and the second resin layer has a water content that is higher than that of the thermochromic layer.

The following will describe the present invention in detail.

As a result of intensive studies, the present inventors have found that sandwiching a thermochromic layer containing vanadium dioxide particles between first and second resin layers and setting water contents of these layers to specific levels can not only suppress the degradation of the vanadium dioxide particles due to moisture and allow the thermochromic properties to be maintained for a long period of time, but also provide the interlayer film with appropriate adhesiveness to laminated glass components. The inventors thus completed the present invention.

FIG. 1 is a partially cut-away cross-sectional view schematically showing an example of the interlayer film for laminated glass of the present invention.

An interlayer film 1 shown in FIG. 1 includes a thermochromic layer 2, a first resin layer 3 disposed on one surface (a first surface) 2a of the thermochromic layer 2, and a second resin layer 4 disposed on the other surface (second surface) of the thermochromic layer 2. The interlayer film 1 is used for obtaining a laminated glass. The interlayer film 1 is an interlayer film for laminated glass. The interlayer film may have a multilayer structure including four or more layers.

The thermochromic layer 2 contains a thermoplastic resin and vanadium dioxide particles 5.

The first resin layer 3 contains a thermoplastic resin. The second resin layer 4 contains a thermoplastic resin. In the present invention, the thermochromic layer 2 is sandwiched between the first and second resin layers 3 and 4. This structure prevents a direct contact of the thermochromic layer 2 to laminated glass components, leading to excellent long-term stability.

In the case of simply producing a laminated glass using an interlayer film containing vanadium dioxide particles in a conventional manner, the resulting laminated glass will show a decrease in the thermochromic properties due to moisture after a long period of use. However, the structure in which the thermochromic layer 2 is sandwiched between the first and second resin layers 3 and 4 enables the interlayer film to maintain excellent thermochromic properties for a long period of time.

In the present invention, the interlayer film for laminated glass contains two resin layers by design, and the thermochromic layer is sandwiched therebetween. A laminated glass with such an interlayer film can have a structure that prevents a direct contact of the thermochromic layer to laminated glass components. Glass used as the laminated glass components has a hydrophilic surface, which is likely to contain moisture. The resin layers interposed between glass and the thermochromic layer can prevent migration of moisture from the glass.

The interlayer film for laminated glass of the present invention includes a first resin layer containing a thermoplastic resin.

Examples of the thermoplastic resin include polyvinyl acetal resins, ethylene-vinyl acetate copolymers, ethylene-acrylic copolymers, polyurethane resins, polyvinyl alcohol resins, and polyester resins. Other thermoplastic resins may be used.

The thermoplastic resin is preferably a polyvinyl acetal resin or an ethylene-vinyl acetate copolymer. From the viewpoint of increasing the adhesiveness of the thermochromic layer to the first resin layer, the thermoplastic resin is preferably a polyvinyl acetal resin.

The polyvinyl acetal resin can be produced by, for example, acetalization of polyvinyl alcohol with an aldehyde. The polyvinyl alcohol can be obtained by, for example, saponification of polyvinyl acetate. The polyvinyl alcohol typically has a degree of saponification in the range of 80 to 99.8 mol %.

The lower limit of the degree of polymerization of the polyvinyl alcohol is preferably 200, more preferably 500, whereas the upper limit thereof is preferably 3,000, more preferably 2,500. If the degree of polymerization is 200 or greater, the laminated glass can have improved penetration resistance. If the degree of polymerization is 3,000 or less, the interlayer film for laminated glass can have good formability.

The aldehyde may be any aldehyde. Typically, a C1-010 aldehyde is suitably used. Examples of the C1-C10 aldehyde include propionaldehyde, n-butylaldehyde, isobutylaldehyde, n-valeraldehyde, 2-ethylbutylaldehyde, n-hexylaldehyde, n-octylaldehyde, n-nonylaldehyde, n-decylaldehyde, formaldehyde, acetoaldehyde, and benzaldehyde. Among these aldehydes, propionaldehyde, n-butylaldehyde, isobutylaldehyde, n-hexylaldehyde, and n-valeraldehyde are preferred. Propionaldehyde, n-butylaldehyde, and isobutylaldehyde are more preferred. n-Butylaldehyde is still more preferred. These aldehydes may be used alone, or in combination of two or more thereof.

From the viewpoint of further increasing the adhesion of the thermochromic layer, the first resin layer, and the second resin layer, the polyvinyl acetal resin preferably has a hydroxy group content (amount of hydroxy groups) in the range of 15 to 40 mol %. The lower limit of the hydroxy group content is more preferably 18 mol %, whereas the upper limit thereof is more preferably 35 mol %. If the hydroxy group content is 15 mol % or more, the adhesion of the layers can be increased. If the hydroxy group content is 40 mol % or less, the interlayer film for laminated glass has higher flexibility, leading to good handleability.

The hydroxy group content in the polyvinyl acetal resin is a mole fraction (expressed in percentage) determined by dividing the amount of ethylene groups to which a hydroxy group is bonded by the amount of all the ethylene groups in the backbone. The amount of ethylene groups to which a hydroxy group is bonded can be determined by, for example, determining the amount of ethylene groups to which a hydroxy group is bonded in polyvinyl alcohol as a raw material in conformity with JIS K 6726 “Testing methods for polyvinyl alcohol.”

The lower limit of the degree of acetylation (amount of acetyl groups) of the polyvinyl acetal resin is preferably 0.1 mol %, more preferably 0.3 mol %, still more preferably 0.5 mol %, whereas the upper limit thereof is preferably 30 mol %, more preferably 25 mol %, still more preferably 20 mol %.

If the degree of acetylation is 0.1 mol % or greater, the polyvinyl acetal resin can have higher compatibility with a plasticizer. If the degree of acetylation is 30 mol % or less, the interlayer film can have high moisture resistance.

The degree of acetylation is a mole fraction (expressed in percentage) determined by subtracting the amounts of ethylene groups to which an acetal group is bonded and ethylene groups to which a hydroxy group is bonded from the total amount of ethylene groups in the backbone and dividing the resulting value by the total amount of ethylene groups in the backbone. The amount of ethylene groups to which an acetal group is bonded can be determined in conformity with JIS K 6728 “Testing methods for polyvinyl butyral,” for example.

The lower limit of the degree of acetalization (in the case of the polyvinyl butyral resin, degree of butyralization) of the polyvinyl acetal resin is preferably 60 mol %, more preferably 63 mol %, whereas the upper limit thereof is preferably 85 mol %, more preferably 75 mol %, still more preferably 70 mol %.

If the degree of acetalization is 60 mol % or greater, the polyvinyl acetal resin has higher compatibility with a plasticizer. If the degree of acetalization is 85 mol % or less, less reaction time is required to produce the polyvinyl acetal resin.

The degree of acetalization is a mole fraction (expressed in percentage) determined by dividing the amount of ethylene groups to which an acetal group is bonded by the amount of all the ethylene groups in the backbone.

The degree of acetalization can be calculated by determining the degree of acetylation (amount of acetyl groups) and the hydroxy group content (amount of vinyl alcohol) in conformity with JIS K 6728 “Testing methods for polyvinyl butyral,” converting the resulting values into mole fractions, and subtracting the resulting values of the degree of acetylation and the hydroxy group content from 100 mol %.

If the polyvinyl acetal resin is a polyvinyl butyral resin, the degree of acetalization (butyralization) and the degree of acetylation (amount of acetyl groups) can be calculated from the values determined in conformity with JIS K 6728 “Testing methods for polyvinyl butyral.”

Examples of the polyester resin include polyalkylene terephthalate resins and polyalkylene naphthalate resins. Examples of the polyalkylene terephthalate resins include polyethylene terephthalate, polybutylene terephthalate, and poly-1,4-cyclohexanedimethylene terephthalate. Among the polyalkylene terephthalate resins, a polyethylene terephthalate resin is preferred because it is chemically stable and further increases the long-term stability of dispersed vanadium dioxide particles.

Examples of the polyalkylene naphthalate resins include polyethylene naphthalate and polybutylene naphthalate.

The interlayer film for laminated glass of the present invention includes a second resin layer containing a thermoplastic resin.

Since the second resin layer is provided, the thermochromic layer is sandwiched between the first and second resin layers. As a result, the migration of moisture to the thermochromic layer can be effectively prevented on both surfaces of the interlayer film.

The thermoplastic resin contained in the second resin layer may be the same as that contained in the first resin layer. Particularly, the thermoplastic resin contained in the second resin layer is preferably a polyvinyl acetal resin or an ethylene-vinyl acetate copolymer.

From the viewpoint of increasing the adhesiveness between the thermochromic layer and the second resin layer, the thermoplastic resin contained in the second resin layer is preferably a polyvinyl acetal resin. In this case, the compatibility of the thermochromic layer and the second resin layer increases, further increasing the adhesiveness between the thermochromic layer and the second resin layer. Preferably, the first resin layer and the second resin layer contain the same thermoplastic resin.

The interlayer film for laminated glass of the present invention includes a thermochromic layer containing a thermoplastic resin and vanadium dioxide particles.

The thermoplastic resin contained in the thermochromic layer may be the same as that contained in the first resin layer. Particularly, the thermoplastic resin contained in the thermochromic layer is preferably a polyvinyl acetal resin, an ethylene-vinyl acetate copolymer resin, or a polyester resin.

From the viewpoint of increasing the long-term stability of the thermochromic layer, the thermoplastic resin contained in the thermochromic layer is preferably a polyester resin. As compared with other thermoplastic resins such as polyvinyl acetal resins and ethylene-vinyl acetate copolymers, polyester resins can suppress the degradation of the vanadium dioxide particles contained in the thermochromic layer and further increase the long-term stability of the thermochromic layer. Particularly, the thermoplastic resin contained in the thermochromic layer is preferably a polyalkylene terephthalate resin.

The first and second thermoplastic resins and the third thermoplastic resin may be the same as or different from one another.

In the case that the thermoplastic resin contained in the thermochromic layer is a polyvinyl acetal resin, the polyvinyl acetal resin preferably has a hydroxy group content (amount of hydroxy groups) in the range of 15 to 40 mol %. The lower limit of the hydroxy group content is more preferably 18 mol %, whereas the upper limit thereof is more preferably 35 mol %, still more preferably 30 mol % or less, particularly preferably 24 mol % or less. If the hydroxy group content is equal to or more than the preferred lower limit, the thermochromic layer can have higher adhesion to other layers. If the hydroxy group content is equal to or less than the preferred upper limit, the interlayer film for laminated glass can have higher flexibility, leading to good handleability. In addition, the long-term stability of dispersed vanadium dioxide particles can be further increased.

In the case that the thermoplastic resin contained in the thermochromic layer is a polyvinyl acetal resin, the lower limit of the degree of acetylation (amount of acetyl groups) of the polyvinyl acetal resin is preferably 0.1 mol %, more preferably 0.3 mol %, still more preferably 0.5 mol %, particularly preferably 1 mol %, most preferably 5 mol %, whereas the upper limit thereof is preferably 30 mol %, more preferably 25 mol %, still more preferably 20 mol %.

If the lower limit of the degree of acetylation is in the above preferred range, the polyvinyl acetal resin can have higher compatibility with a plasticizer. In addition, the long-term stability of dispersed vanadium dioxide particles can be further increased. If the upper limit of the degree of acetylation is in the above preferred range, the interlayer film has higher moisture resistance.

In the case that the thermoplastic resin contained in the thermochromic layer is a polyvinyl acetal resin, the lower limit of the degree of acetalization (in the case of a polyvinyl butyral resin, the degree of butyralization) of the polyvinyl acetal resin is 60 mol %, more preferably 63 mol %, whereas the upper limit thereof is preferably 85 mol %, more preferably 75 mol %, still more preferably 70 mol %.

If the lower limit of the degree of acetalization is in the above preferred range, the polyvinyl acetal resin can have higher compatibility with a plasticizer. In addition, the long-term stability of dispersed vanadium dioxide particles can be further increased. If the upper limit of the degree of acetalization is in the above preferred range, less time is required to produce the polyvinyl acetal resin.

The thermochromic layer contains vanadium dioxide particles.

Since having thermochromic properties, the vanadium dioxide particles can impart excellent thermochromic properties to the interlayer film for laminated glass and the laminated glass of the present invention.

Infrared rays, which have a wavelength longer than that of visible light, that is, 780 nm or longer, have less energy than ultraviolet rays. However, infrared rays have great thermal effects. Once absorbed by a substance, infrared rays are emitted as heat. Infrared rays are thus generally called heat rays. The use of vanadium dioxide particles allows effective blocking of infrared rays (heat rays) at or above the phase transition temperature of vanadium dioxide, and effective transmission thereof at or below the phase transition temperature of vanadium dioxide.

The vanadium dioxide particles may be 100% pure vanadium dioxide particles, or may be substituted vanadium dioxide particles in which some of the vanadium atoms in the vanadium dioxide are substituted with a metal atom other than vanadium.

In the substituted vanadium dioxide particles, the metal atom other than vanadium may be any metal atom. Examples thereof include tungsten, molybdenum, niobium, and tantalum. The metal atom other than vanadium is preferably at least one selected from the group consisting of tungsten, molybdenum, niobium, and tantalum.

Vanadium dioxide has various crystalline phases, and undergoes reversible phase transition between a monoclinic phase and a tetragonal phase (rutile form). Its phase transition temperature is about 68° C. The phase transition temperature can be adjusted by substituting some of the vanadium atoms in the vanadium dioxide with a metal atom other than vanadium. Accordingly, the thermochromic properties of the interlayer film for laminated glass to be obtained can be adjusted by appropriately selecting vanadium dioxide particles or substituted vanadium dioxide particles or by appropriately selecting atomic species for substitution or the rate of substitution in the substituted vanadium dioxide particles.

In the case of using the substituted vanadium dioxide particles, the lower limit of the rate of substitution of a metal atom is 0.1 at. %, whereas the upper limit thereof is preferably 10 at. %. If the rate of substitution is 0.1 at. % or more, the phase transition temperature of the substituted vanadium dioxide particles can be easily adjusted. If it is 10 at. % or less, excellent thermochromic properties can be achieved.

The rate of substitution means the proportion (expressed in percentage) of the number of substituted atoms in the total number of vanadium atoms and substituted atoms.

The vanadium dioxide particles or the substituted vanadium dioxide particles may be particles consisting substantially only of vanadium dioxide or substituted vanadium dioxide, or may be particles containing core particles and vanadium dioxide or substituted vanadium dioxide attached to the surface of the core particles.

Examples of the core particles include inorganic particles such as particles of silicon oxide, silica gel, titanium oxide, glass, zinc oxide, zinc hydroxide, aluminum oxide, aluminum hydroxide, titanium hydroxide, zirconium oxide, zirconium hydroxide, zirconium phosphate, hydrotalcite compounds, fired products of hydrotalcite compounds, and calcium carbonate.

The lower limit of the average particle size of the vanadium dioxide particles is preferably 0.01 μm, more preferably 0.02 μm, whereas the upper limit thereof is preferably 100 μm. The lower limit is still more preferably 0.1 μm. If the average particle size is equal to or greater than the preferred lower limit, the thermochromic properties can be sufficiently increased. If the average particle size is equal to or less than the preferred upper limit, the dispersibility of the vanadium dioxide particles can be increased.

The “average particle size” means the volume average particle size. The average particle size can be determined with, for example, a particle size distribution analyzer (“UPA-EX150” available from Nikkiso Co., Ltd.).

The amount of the vanadium dioxide particles in the thermochromic layer is not limited. The lower limit of the amount of the vanadium dioxide particles is preferably 0.01 parts by mass, more preferably 0.1 parts by mass, whereas the upper limit thereof is preferably 3 parts by mass, more preferably 2 parts by mass, based on 100 parts by mass of the thermoplastic resin. If the amount of vanadium dioxide particles in the thermochromic layer is within the above preferred range, the thermochromic properties can be sufficiently increased.

The amount of the vanadium dioxide particles in 100% by mass of the thermochromic layer is preferably 0.01% by mass or more, more preferably 0.1% by mass or more, still more preferably 1% by mass or more, particularly preferably 1.5% by mass or more, whereas it is preferably 6% by mass or less, more preferably 5.5% by mass or less, still more preferably 4% by mass or less, particularly preferably 3.5% by mass or less, most preferably 3.0% by mass or less. If the amount of vanadium dioxide particles in the thermochromic layer is within the above preferred range, the thermochromic properties can be sufficiently increased.

In order to improve the dispersibility of the vanadium dioxide particles, the thermochromic layer may contain a dispersant such as a glycerol ester or polycarboxylic acid.

The glycerol ester is not limited. Examples thereof include decaglycerol monostearate, decaglycerol tristearate, decaglycerol decastearate, hexaglycerol monostearate, hexaglycerol distearate, hexaglycerol tristearate, hexaglycerol pentastearate, tetraglycerol monostearate, tetraglycerol tristearate, tetraglycerol pentastearate, polyglycerol stearate, glycerol monostearate, decaglycerol monooleate, decaglycerol decaoleate, hexaglycerol monooleate, hexaglycerol pentaoleate, tetraglycerol monooleate, tetraglycerol pentaoleate, polyglycerol oleate, glycerol monooleate, 2-ethylhexanoic acid triglyceride, capric acid monoglyceride, capric acid triglyceride, myristic acid monoglyceride, myristic acid triglyceride, decaglycerol monocaprylate, polyglycerol caprylate, caprylic acid triglyceride, decaglycerol monolaurate, hexaglycerol monolaurate, tetraglycerol monolaurate, polyglycerol laurate, decaglycerol heptabehenate, decaglycerol dodecabehenate, polyglycerol behenate, decaglycerol erucate, polyglycerol erucate, tetraglycerol condensed ricinoleate, hexaglycerol condensed ricinoleate, and polyglycerol condensed ricinoleate.

Commercially available glycerol esters include SY-Glyster CR-ED (available from SAKAMOTO YAKUHIN KOGYO Co., Ltd., polyglycerol condensed ricinoleate) and SY-Glyster PO-5S (available from SAKAMOTO YAKUHIN KOGYO Co., Ltd., hexaglycerol penta-oleate).

The polycarboxylic acid is not limited, and may be, for example, a polycarboxylic acid polymer obtainable by grafting a polyoxyalkylene to a polymer containing a carboxy group in the backbone.

Commercially available polycarboxylic acids include MALIALIM series (e.g., AFB-0561, AKM-0531, AFB-1521, AEM-3511, AAB-0851, AWS-0851, AKM-1511-60) available from NOF Corp.

The lower limit of the amount of the dispersant in the thermochromic layer is 1 part by mass, whereas the upper limit thereof is preferably 10,000 parts by mass for 100 parts by mass of the vanadium dioxide particles. The lower limit is more preferably 10 parts by mass, whereas the upper limit is more preferably 1,000 parts by mass. The lower limit is still more preferably 30 parts by mass, whereas the upper limit is still more preferably 300 parts by mass. If the amount of the dispersant is equal to or more than the above lower limit, the dispersibility of the vanadium dioxide particles improves, which improves the transparency of the thermochromic layer, leading to higher transparency of the interlayer film for laminated glass. If the amount of the dispersant is equal to or less than the upper limit, the dispersant is less likely to precipitate, which improves the transparency of the thermochromic layer, leading to higher transparency of the interlayer film for laminated glass.

The thermochromic layer has a water content of less than 0.4% by mass. The thermochromic layer with a water content of less than 0.4% by mass can effectively prevent a decrease in the thermochromic properties. The upper limit of the water content is preferably 0.39% by mass. The lower limit thereof is not limited, but is preferably 0.001% by mass.

The water content herein can be determined by the following method.

A specimen (about 10 g) is taken from the thermochromic layer, and allowed to stand in a lidded desiccator containing silica gel. The lid of the desiccator is then tightly closed. Subsequently, the desiccator is allowed to stand in a constant temperature room set at 23° C. Thus, the specimen is dried. The drying is continued until no weight change occurs. Thereafter, the weight of the specimen is measured. The water content of the thermochromic layer is determined by the following equation.

Water content (% by mass) of thermochromic layer=[(weight of specimen before drying−weight of specimen after drying)×100]/(weight of specimen before drying)

In the interlayer film for laminated glass of the present invention, the first resin layer and the second resin layer each have a higher water content than the thermochromic layer. As a result, as compared with the case that the first and second resin layers have a water content equal to or lower than that of the thermochromic layer, the interlayer film can suppress the degradation of the vanadium dioxide particles due to moisture and provide appropriate adhesiveness to laminated glass components. This advantageously leads to production of a laminated glass excellent in long-term stability and shatterproof properties.

The difference in water content between each of the first and second resin layers and the thermochromic layer is preferably 0.01 to 10% by mass, more preferably 0.1 to 3% by mass, still more preferably 0.5 to 1% by mass.

The lower limit of the water content in each of the first and second resin layers is preferably 0.01% by mass, whereas the upper limit thereof is preferably 10% by mass. If the water content is within the above range, adhesiveness to laminated glass components can be appropriate. The water content in the first and second resin layers can be determined in the same manner as that of the thermochromic layer. The lower limit of the water content in each of the first and second resin layers is more preferably 0.1% by mass, still more preferably 0.2% by mass, particularly preferably 0.3% by mass, whereas the upper limit thereof is more preferably 5% by mass, still more preferably 3% by mass, particularly preferably 1% by mass.

In the present invention, from the viewpoint of further increasing the adhesion of the layers, the thermochromic layer and the first and second resin layers preferably contain a plasticizer. Especially when the thermoplastic resin contained in the thermochromic layer is a polyvinyl acetal resin, these layers preferably contain a plasticizer.

The plasticizer is not limited, and may be a conventionally known plasticizer. A single plasticizer may be used, or two or more plasticizers may be used in combination.

Examples of the plasticizer include organic ester plasticizers such as monobasic organic acid esters and polybasic organic acid esters and phosphoric acid plasticizers such as organophosphoric acid plasticizers and organophosphorous acid plasticizers. Among these plasticizers, organic ester plasticizers are preferred. The plasticizer is preferably a liquid plasticizer.

The monobasic organic acid esters are not limited. Examples thereof include glycol esters obtained by reaction of a glycol and a monobasic organic acid; and esters of triethylene glycol or tripropylene glycol with a monobasic organic acid. Examples of the glycol include triethylene glycol, tetraethylene glycol, and tripropylene glycol. Examples of the monobasic organic acid include butyric acid, isobutyric acid, caproic acid, 2-ethylbutyric acid, heptyl acid, n-octyl acid, 2-ethylhexanoic acid, n-nonyl acid, and decanoic acid.

The polybasic organic acid esters are not limited, and examples thereof include ester compounds of a polybasic organic acid with a C4-C8 linear or branched alcohol. Examples of the polybasic acid include adipic acid, sebacic acid, and azelaic acid.

The organic ester plasticizers are not limited, and examples thereof include triethylene glycol di-2-ethylbutyrate, triethylene glycol di-2-ethylhexanoate, triethylene glycol dicaprylate, triethylene glycol di-n-octanoate, triethylene glycol di-n-heptanoate, tetraethylene glycol di-n-heptanoate, dibutyl sebacate, dioctyl azelate, dibutyl carbitol adipate, ethylene glycol di-2-ethylbutyrate, 1,3-propylene glycol di-2-ethylbutyrate, 1,4-butylene glycol di-2-ethylbutyrate, diethylene glycol di-2-ethylbutyrate, diethylene glycol di-2-ethylhexanoate, dipropylene glycol di-2-ethylbutyrate, triethylene glycol di-2-ethylpentanoate, tetraethylene glycol di-2-ethylbutyrate, diethylene glycol dicaprylate, dihexyl adipate, dioctyl adipate, hexylcyclohexyl adipate, mixtures of heptyl adipate and nonyl adipate, diisononyl adipate, diisodecyl adipate, heptylnonyl adipate, dibutyl sebacate, oil-modified sebacic alkyds, and mixtures of phosphoric acid esters and adipic acid esters. Other organic ester plasticizers may be used.

The organophosphoric acid plasticizers are not limited. Examples thereof include tributoxyethyl phosphate, isodecylphenyl phosphate, and triisopropyl phosphate.

The plasticizer is preferably at least one of triethylene glycol di-2-ethylhexanoate (3GO) and triethylene glycol di-2-ethylbutyrate (3GH), and more preferably triethylene glycol di-2-ethylhexanoate.

The amount of the plasticizer in each of the thermochromic layer, the first resin layer, and the second resin layer is not limited. The lower limit of the amount of the plasticizer is preferably 25 parts by mass, more preferably 30 parts by mass, whereas the upper limit thereof is preferably 80 parts by mass, more preferably 60 parts by mass, based on 100 parts by mass of the thermoplastic resin. If the amount of the plasticizer meets the above preferred lower limit, the laminated glass can have further increased penetration resistance. If the amount of the plasticizer meets the above preferred upper limit, the interlayer film for laminated glass can have further increased transparency.

The thermochromic layer, the first resin layer, and the second resin layer may contain different amounts of the plasticizer. For example, if at least one of the thermochromic layer, the first resin layer, and the second resin layer contains 55 parts by mass or more of the plasticizer based on 100 parts by mass of the thermoplastic resin, the laminated glass can have higher sound insulating properties.

The first and second resin layers may contain an ultraviolet shielding agent.

The ultraviolet shielding agent includes ultraviolet absorbers. Conventionally known, typical ultraviolet shielding agents include metal ultraviolet shielding agents, metal oxide ultraviolet shielding agents, benzotriazole ultraviolet shielding agents, benzophenone ultraviolet shielding agents, triazine ultraviolet shielding agents, benzoate ultraviolet shielding agents, malonic acid ester ultraviolet shielding agents, and oxanilide ultraviolet shielding agents.

Examples of the metal ultraviolet shielding agents include platinum particles, platinum particles having a surface coated with silica, palladium particles, and palladium particles having a surface coated with silica. The ultraviolet shielding agent is preferably other than heat insulating particles. The ultraviolet shielding agent is preferably a benzotriazole ultraviolet shielding agent, a benzophenone ultraviolet shielding agent, a triazine ultraviolet shielding agent, or a benzoate ultraviolet shielding agent, more preferably a benzotriazole ultraviolet shielding agent.

Examples of the metal oxide ultraviolet shielding agents include zinc oxide, titanium oxide, and cerium oxide. These metal oxide ultraviolet shielding agents may have a coated surface. Examples of materials for coating the surface of the metal oxide ultraviolet shielding agents include insulation metal oxides, hydrolyzable organosilicon compounds, and silicone compounds.

The insulation metal oxides include silica, alumina, and zirconia. The insulation metal oxides have a band gap energy of, for example, 5.0 eV or greater.

Examples of the benzotriazole ultraviolet shielding agents include 2-(2′-hydroxy-5′-methylphenyl)benzotriazole (“Tinuvin P” available from BASF), 2-(2′-hydroxy-3′,5′-di-t-butylphenyl)benzotriazole (“Tinuvin 320” available from BASF), 2-(2′-hydroxy-3′-t-butyl-5-methylphenyl)-5-chlorobenzotriazole (“Tinuvin 326” available from BASF), and 2-(2′-hydroxy-3′,5′-di-amylphenyl)benzotriazole (“Tinuvin 328” available from BASF). For excellent ability to absorb ultraviolet rays, the ultraviolet shielding agent is preferably a benzotriazole ultraviolet shielding agent containing a halogen atom, and more preferably a benzotriazole ultraviolet shielding agent containing a chlorine atom.

Examples of the benzophenone ultraviolet shielding agents include octabenzone (“Chimassorb 81” available from BASF).

Examples of the triazine ultraviolet shielding agents include 2-(4,6-diphenyl-1,3,5-triazin-2-yl)-5-[(hexyl)oxy]-phenol (“Tinuvin 1577FF” available from BASF).

Examples of the benzoate ultraviolet shielding agents include 2,4-di-tert-butylphenyl-3,5-di-tert-butyl-4-hydroxy benzoate (“tinuvin 120” available from BASF).

Examples of the malonic acid ester ultraviolet shielding agents include malonic acid [(4-methoxyphenyl)-methylene]-dimethyl ester (Hostavin PR-25 available from Clariant (Japan) K.K.).

Examples of the oxanilide ultraviolet shielding agents include 2-ethyl-2′-ethoxy-oxalanilide (Sanduvor V SU available from Clariant (Japan) K.K.).

In the present invention, the thermochromic layer, which will be described later, may or may not contain an ultraviolet shielding agent. From the viewpoint of further increasing the long-term stability of the thermochromic properties, the thermochromic layer preferably contains an ultraviolet shielding agent.

The amount of the ultraviolet shielding agent in each of the thermochromic layer, the first resin layer, and the second resin layer is not limited. From the viewpoint of further increasing the initial thermochromic properties and the thermochromic properties after aging, the lower limit of the amount of the ultraviolet shielding agent based on 100 parts by mass of the thermoplastic resin is preferably 0.3 parts by mass, more preferably 0.4 parts by mass, still more preferably 0.5 parts by mass, whereas the upper limit thereof is preferably 3 parts by mass, more preferably 2.5 parts by mass, still more preferably 2 parts by mass. From the viewpoint of further increasing the initial thermochromic properties and the thermochromic properties after aging, the amount of the ultraviolet shielding agent in 100% by mass of each of the first and second resin layers is 0.1% by mass or more, more preferably 0.2% by mass or more, still more preferably 0.3% by mass or more, particularly preferably 0.5% by mass or more, and is preferably 2.5% by mass or less, more preferably 2% by mass or less, still more preferably 1% by mass or less, particularly preferably 0.8% by mass or less. In particular, if the amount of the ultraviolet shielding agent in 100% by mass of each of the first and second resin layers is 0.2% by mass or more, the decrease in thermochromic properties of the laminated glass after aging can be markedly suppressed.

From the viewpoint of further increasing the initial thermochromic properties and the thermochromic properties after aging, the amount of the ultraviolet shielding agent in 100% by mass of the thermochromic layer is preferably 0.1% by mass or more, more preferably 0.2% by mass or more, still more preferably 0.3% by mass or more, particularly preferably 0.5% by mass or more, and is preferably 2.5% by mass or less, more preferably 2% by mass or less, still more preferably 1% by mass or less, particularly preferably 0.8% by mass or less. In particular, if the amount of the ultraviolet shielding agent in 100% by mass of the thermochromic layer is 0.3% by mass or more, the decrease in the thermochromic properties after aging of the laminated glass can be markedly suppressed.

The first and second resin layers may contain an adhesion adjuster in order to adjust the adhesion to laminated glass components. Suitable adhesion adjusters include alkali metal salts and alkaline earth metal salts of organic acids or inorganic acids. The alkali metal salts and the alkaline earth metal salts are not limited. Examples thereof include salts of potassium, sodium, and magnesium. The organic acids are not limited. Examples thereof include carboxylic acids such as octylic acid, hexylic acid, butyric acid, acetic acid, and formic acid. The inorganic acids are not limited. Examples thereof include hydrochloric acid and nitric acid. These adhesion adjusters may be used alone, or in combination of two or more thereof.

Among the alkali metal salts and alkaline earth metal salts of organic acids or organic acids, alkali metal salts of C2-C16 organic acids and alkaline earth metal salts of C2-C16 organic acids are preferred, with magnesium salts of C2-C16 carboxylic acids being more preferred. The magnesium salts of C2-C16 carboxylic acids are not limited. Examples thereof include magnesium acetate, magnesium propionate, magnesium 2-ethylbutanoate, and magnesium 2-ethylhexanoate. These may be used alone, or in combination of two or more thereof.

The amount of the adhesion adjuster is preferably 0.001 to 0.5 parts by mass based on 100 parts by mass of the thermoplastic resin contained in each of the first and second resin layers. If the amount is 0.001 parts by mass or more, the adhesion of the peripheral portion is less likely to decrease even under high-humidity atmosphere. If the amount is 0.5 parts by mass or less, the interlayer film for laminated glass to be obtained has an adhesion that is not too low and does not lose the transparency. The amount of the adhesion adjuster is more preferably 0.01 to 0.2 parts by mass based on 100 parts by mass of the thermoplastic resin contained in each of the first and second resin layers.

The thermochromic layer and the first and second resin layers may each optionally contain additives such as an antioxidant, a light stabilizer, a flame retardant, an antistatic agent, pigment, dye, a moisture-proof agent, a fluorescent brightner, and an infrared ray absorber. These additives may be used alone, or in combination of two or more thereof.

The interlayer film for laminated glass of the present invention may further contain layer(s) other than the thermochromic layer and the first and second resin layers. In addition, layer(s) other than the thermochromic layer and the first and second resin layers may be sandwiched between the thermochromic layer and the first resin layer and/or between the thermochromic layer and the second resin layer.

The interlayer film for laminated glass of the present invention may have any thickness. The thickness of the interlayer film for laminated glass means the total thickness of the layers constituting the interlayer film. That is, the thickness of the interlayer film for laminated glass means the total thickness of the thermochromic layer and the first and second resin layers. From the viewpoint of practical use and sufficient increase in the thermochromic properties, the lower limit of the thickness of the interlayer film for laminated glass of the present invention is preferably 0.1 mm, more preferably 0.25 mm, whereas the upper limit thereof is preferably 3 mm, more preferably 1.5 mm. If the interlayer film is too thin, the laminated glass tends to have lower penetration resistance.

From the viewpoint of practical use and sufficient increase in the thermochromic properties, the lower limit of the thickness of the thermochromic layer is preferably 0.001 mm, more preferably 0.05 mm, whereas the upper limit thereof is preferably 0.8 mm, more preferably 0.6 mm.

From the viewpoint of practical use, and from the viewpoint of sufficiently maintaining the thermochromic properties for a long period of time, the lower limit of the thickness of each of the first and second resin layers is preferably 0.001 mm, more preferably 0.2 mm, whereas the upper limit thereof is preferably 0.8 mm, more preferably 0.6 mm.

The interlayer film for laminated glass of the present invention can be produced by any method. For example, the interlayer film for laminated glass of the present invention can be produced by separately producing the thermochromic layer, the first resin layer, and the second resin layer and then laminating and pressing the layers. Alternatively, the interlayer film for laminated glass of the present invention can be produced by preparing a composition for forming the thermochromic layer and compositions for forming the first and second resin layers and then co-extruding these compositions.

Exemplary methods for producing the thermochromic layer include a method involving extruding or pressing a mixture containing a thermoplastic resin, vanadium dioxide particles, and optionally additives to produce a thermochromic layer, and a method involving extruding or pressing a mixture containing a dispersion of vanadium dioxide particles, a thermoplastic resin, and optionally additives to produce a thermochromic layer. The mixture can be produced with, for example, a bead mill, a mixing roll, an extruder, a plastograph, a kneader, a Banbury mixer, or a calender roll.

The dispersion preferably contains the vanadium dioxide particles, the dispersant, and an organic solvent. The upper limit of the volume average particle size of the vanadium dioxide particles in the dispersion is preferably 100 μm. If the volume average particle size is 100 μm or less, an interlayer film for laminated glass having excellent transparency can be produced. The upper limit of the volume average particle size is more preferably 10 μm. The lower limit of the volume average particle size is not limited, but the practical limit is considered to be 10 nm. The volume average particle size herein means the particle size that divides particles into two equal-volume groups, one consisting of particles with a particle size greater than the volume average particle size, the other consisting of particles with a particle size smaller than the volume average particle size.

In the methods for producing the thermochromic layer, a step of adjusting the water content of the thermochromic layer is subsequently performed. The water content can be adjusted by, for example, allowing the obtained thermochromic layer to stand at a certain temperature and humidity for a certain period of time. For example, it is adjusted by allowing the thermochromic layer to stand under constant temperature and humidity conditions of 23° C. and a humidity of 3% for several hours to several days. This operation is referred to as humidity control. The water content of the thermochromic layer can be adjusted by appropriately setting the temperature or the humidity during the humidity control. For example, for a low water content of the thermochromic layer, the humidity control is performed at a low temperature and a low humidity. Specifically, for a low water content, the temperature during the humidity control is preferably lower than 23° C., and the humidity during the humidity control is 3% or less. For a high water content of the thermochromic layer, the humidity control is performed at a high temperature and a high humidity. Specifically, for a high water content, the temperature during the humidity control is preferably 23° C. or higher, and the humidity during the humidity control is preferably 50% or higher.

The adjustment of the water content may be performed with, for example, a thermo-hygrostat.

Exemplary methods for producing the first and second resin layers include a method involving extruding or pressing a mixture of a thermoplastic resin and optionally additives to produce a resin layer, and a method involving extruding or pressing a mixture of a plasticizer-containing solution, a thermoplastic resin, and optionally additives to provide the first and the second resin layers.

The first and second resin layers may be optionally subjected to the step of adjusting the water content as the thermochromic layer.

The interlayer film for laminated glass of the present invention is used for obtaining a laminated glass. For example, a laminated glass can be obtained by interposing the interlayer film for laminated glass of the present invention between laminated glass components.

FIG. 2 is a partially cut-away cross-sectional view showing an example of a laminated glass including the interlayer film for laminated glass of the present invention.

A laminated glass 11 shown in FIG. 2 includes an interlayer film 1 and laminated glass components 12 and 13. The interlayer film 1 is an interlayer film for laminated glass. The interlayer film 1 is interposed between the laminated glass components 12 and 13. Accordingly, in the laminated glass 11, the laminated glass component 12, the interlayer film 1, and the laminated glass component 13 are laminated in the stated order. The laminated glass component 12 is disposed on an outer surface 3a of the first resin layer 3. The laminated glass component 13 is disposed on an outer surface 4a of the second resin layer 4.

The laminated glass components may be, for example, glass plates or polyethylene terephthalate (PET) films. The laminated glass includes a laminated glass including a glass plate and a PET film with an interlayer film interposed therebetween, as well as a laminated glass including two glass plates with an interlayer film interposed therebetween. The laminated glass is a laminate including a glass plate and preferably contains at least one glass plate.

Examples of the glass plates include inorganic glass and organic glass. Examples of the inorganic glass include float plate glass, heat-absorbing plate glass, heat-reflecting plate glass, polished plate glass, molded plate glass, mesh-reinforced plate glass, wire-reinforced plate glass, and green glass. Preferred among these kinds of inorganic glass is heat-absorbing plate glass because it has high thermochromic properties. The heat-absorbing plate glass is specified in JIS R 3208. The organic glass is synthetic resin glass that substitutes for inorganic glass. Examples of the organic glass include polycarbonate plates and poly(meth)acrylic resin plates. Examples of the poly(meth)acrylic resin plate include polymethyl(meth)acrylate plates.

The laminated glass components each preferably have a thickness of 1 mm or more, preferably 5 mm or less, more preferably 3 mm or less. In the case of using a glass plate as a laminated glass component, the thickness of the glass plate is preferably 1 mm or more and preferably 5 mm or less, more preferably 3 mm or less. In the case of using a PEF film as a laminated glass component, the thickness of the PET film is preferably in the range of 0.03 to 0.5 mm.

A laminated glass obtained by sandwiching the interlayer film for laminated glass of the present invention between two 2-mm-thick float glass plates, the glass plates being in conformity with JIS R 3202, preferably has a visible light transmittance of 20% or greater.

The laminated glass of the present invention preferably has an infrared transmittance at 100° C. of 70% or less, more preferably 50% or less. The infrared transmittance of the laminated glass can be measured in conformity with JIS R 3106 (1998). A laminated glass obtained by sandwiching the interlayer film for laminated glass of the present invention between two 2-mm-thick float glass plates, the glass plates being in conformity with JIS R 3202, preferably has an infrared transmittance of 70% or less, more preferably 50% or less.

The laminated glass of the present invention preferably has a haze value of 20% or less, more preferably 10% or less, still more preferably 5% or less, particularly preferably 4% or less. Since the interlayer film for laminated glass of the present invention includes the thermochromic layer and the first and second resin layers, the laminated glass can have a low haze value. The haze value of the laminated glass can be measured in conformity with JIS K 6714.

The laminated glass of the present invention can be produced by any method. For example, a pair of laminated glass components with the interlayer film for laminated glass of the present invention interposed therebetween is pressed by a pressure roll or vacuumed under reduced pressure in a rubber bag so that the air remaining between the laminated glass components and the interlayer film is removed. This is followed by preliminary bonding at about 70° C. to 110° C. The resulting laminate is put in an autoclave or pressed so that it is pressure-bonded at about 120° C. to 150° C. and a pressure of 1 to 1.5 MPa. Thus, the laminated glass can be obtained.

The laminated glass of the present invention can be used in applications such as automobiles, railcars, aircraft, boats and ships, and buildings. The laminated glass is particularly suitably used for front glass, side glass, rear glass, roof glass, or the like of automobiles. The laminated glass of the present invention can also be used in other applications. Since having high thermochromic properties and a low infrared transmittance, the laminated glass of the present invention are suitably used in automobiles or buildings.

### Advantageous Effects of Invention

The present invention provides an interlayer film for laminated glass that can maintain excellent thermochromic properties for a long period of time and have appropriate adhesiveness to laminated glass components, and also a laminated glass including the interlayer film for laminated glass.

### BRIEF DESCRIPTION OF DRAWINGS

FIG. 1 is a partially cut-away cross-sectional view schematically showing an example of the interlayer film for laminated glass of the present invention.

FIG. 2 is a partially cut-away cross-sectional view showing an example of a laminated glass including the interlayer film for laminated glass of the present invention.

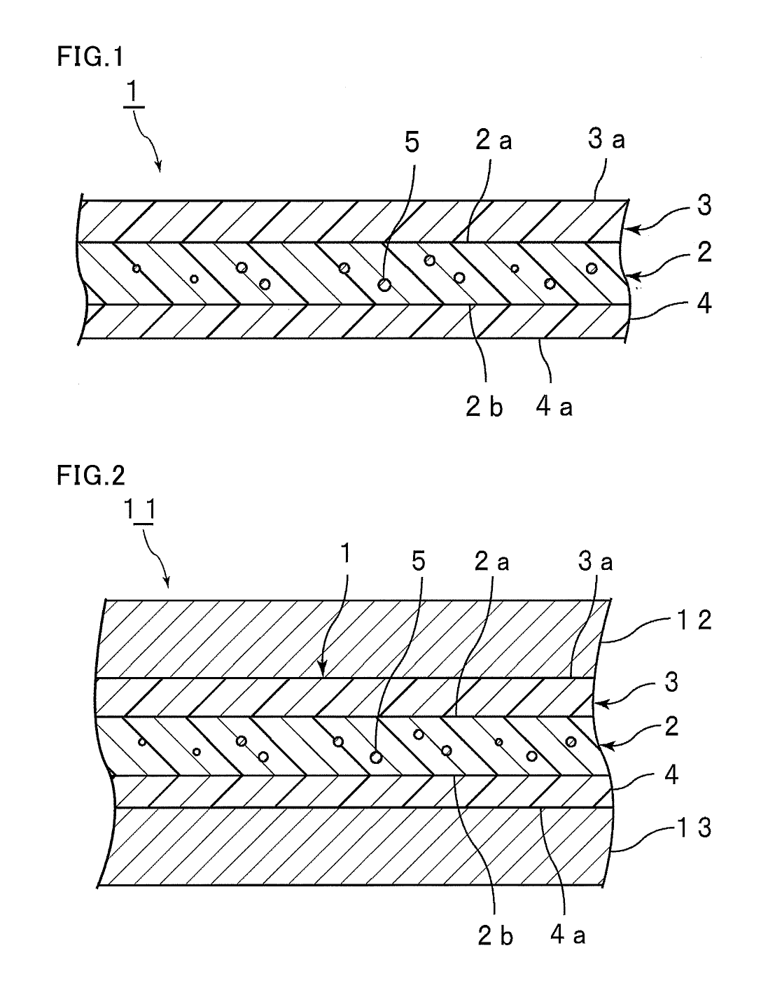

### DESCRIPTION OF EMBODIMENTS

The embodiments of the present invention will be described in detail below based on, but not limited to, examples.

### Example 1

### (1) Production of Thermochromic Layer

An amount of 0.05 parts by mass of vanadium dioxide particles (average particle size: 77 μm, available from Shinko Chemical Co., Ltd.) and 0.5 parts by mass of polycarboxylic acid (AFB-0561, available from NOF Corporation) as a dispersant were added to 28 parts by mass of triethylene glycol di-2-ethylhexanoate (3GO) as a plasticizer. The resulting mixture was mixed with a horizontal microbead mill. Thus, a vanadium dioxide particle dispersion was obtained. The vanadium dioxide particles in the dispersion had a volume average particle size of 132 nm.

The entire amount of the vanadium dioxide particle dispersion was added to 72 parts by mass of a polyvinyl butyral resin (PVB1) (average degree of polymerization: 1700, hydroxy group content: 30.5 mol %, degree of acetylation: 1 mol %, degree of butyralization: 68.5 mol %). The resulting mixture was sufficiently melted and kneaded with a mixing roll. The kneaded product was sandwiched between polytetrafluoroethylene (PTFE) sheets. The resulting laminate was pressurized via a 100-μm-thick spacer using a hot press under conditions of 150° C. and 100 kg/cm² for 15 minutes, whereby a thermochromic layer with a thickness of 100 μm was obtained.

Thereafter, the obtained thermochromic layer was allowed to stand at constant temperature and humidity of a temperature of 23° C. and a humidity of 3%.

### (2) Production of First Resin Layer

Into 40 parts by mass of triethylene glycol di-2-ethylhexanoate (3GO) were dissolved 0.5 parts by mass of 2-(2′-hydroxy-3′-t-butyl-5-methylphenyl)-5-chlorobenzotriazole (Tinuvin 326, available from BASF) as an ultraviolet absorber and magnesium acetate as an adhesion adjuster in an amount that gives a magnesium content of 50 ppm in the first resin layer to be obtained. The entire amount of the solution thus prepared was sufficiently kneaded together with a polyvinyl butyral resin (PVB1) using a mixing roll, whereby a resin composition was prepared. The resin composition was sandwiched between polytetrafluoroethylene (PTFE) sheets. The resulting laminate was pressurized via a 330-μm-spacer using a hot press under conditions of 150° C. and 100 kg/cm² for 15 minutes, whereby a first resin layer with a thickness of 330 μm was obtained.

Thereafter, the obtained first resin layer was allowed to stand at constant temperature and humidity of a temperature of 23° C. and a humidity of 3%.

### (3) Production of Second Resin Layer

Into 40 parts by mass of triethylene glycol di-2-ethylhexanoate (3GO) were dissolved 0.5 parts by mass of 2-(2′-hydroxy-3′-t-butyl-5-methylphenyl)-5-chlorobenzotriazole (Tinuvin 326, available from BASF) as an ultraviolet absorber and magnesium acetate as an adhesion adjuster in an amount that gives a magnesium content of 50 ppm in the second resin layer to be obtained. The entire amount of the solution thus prepared was sufficiently kneaded with a polyvinyl butyral resin (PVB1) with a mixing roll, whereby a resin composition was prepared. The resin composition was sandwiched between polytetrafluoroethylene (PTFE) sheets. The resulting laminate was pressurized via a 330-μm-spacer using a hot press under conditions of 150° C. and 100 kg/cm² for 15 minutes, whereby a second resin layer with a thickness of 330 μm was obtained.

Thereafter, the obtained second resin layer was allowed to stand at constant temperature and humidity of a temperature of 23° C. and a humidity of 3%.

### (4) Production of Interlayer Film for Laminated Glass

The above layers were stacked in order of first resin layer/thermochromic layer/second resin layer in the thickness direction. The stack was pressed at 150° C. for 5 minutes, whereby a three-layered interlayer film for laminated glass with a thickness of 760 μm was obtained.

### (5) Production of Laminated Glass

The obtained interlayer film was cut into a size of 5 cm length×5 cm width. Subsequently, two float glass plates (5 cm length×5 cm width×2 mm thickness) that were in conformity with JIS R 3202 were prepared. The cut interlayer film was interposed between the float glass plates. The workpiece was held at 90° C. for 30 minutes with a vacuum laminator and vacuum-pressed. In this manner, a laminated glass was obtained.

### Example 2

An interlayer film for laminated glass and a laminated glass were obtained in the same manner as in Example 1 except that, in the step of “(1) Production of thermochromic layer,” the obtained thermochromic layer was allowed to stand at constant temperature and humidity of a temperature of 23° C. and a humidity of 3% for a longer time than in Example 1.

### Example 3

An interlayer film for laminated glass and a laminated glass were obtained in the same manner as in Example 1 except that, in the step of “(1) Production of thermochromic layer,” the obtained thermochromic layer was allowed to stand at constant temperature and humidity of a temperature of 23° C. and a humidity of 3% for a longer time than in Example 2.

### Example 4

### (1) Production of Thermochromic Layer

To 100 parts by mass of a polyethylene terephthalate resin was added 0.05 parts by mass of vanadium dioxide particles. The resin was melted and kneaded, so that the vanadium dioxide particles were uniformly dispersed in the resin. The kneaded product was extruded using a melt extruder provided with a T-die. In this manner, a thermochromic layer with a thickness of 100 μm was obtained.

The thermochromic layer was allowed to stand at constant temperature and humidity of a temperature of 23° C. and a humidity of 3%.

### (2) Production of Interlayer Film for Laminated Glass and Laminated Glass

An interlayer film for laminated glass and a laminated glass were obtained in the same manner as in Example 1 except that the obtained thermochromic layer was used.

### Example 5

An interlayer film for laminated glass and a laminated glass were obtained in the same manner as in Example 4 except that, in the step of “(1) Production of thermochromic layer,” the obtained thermochromic layer was allowed to stand at constant temperature and humidity of a temperature of 23° C. and a humidity of 3% for shorter time than in Example 4.

### Example 6

An interlayer film for laminated glass and a laminated glass were obtained in the same manner as in Example 1 except that, in the step of “(1) Production of thermochromic layer,” a polyvinyl butyral resin (PVB2) (average degree of polymerization: 2,300, hydroxy group content: 22 mol %, degree of acetylation: 13 mol %, degree of butyralization: 65 mol %) was used instead of the polyvinyl butyral resin (PVB1).

### Example 7

An interlayer film for laminated glass and a laminated glass were obtained in the same manner as in Example 1 except that, in the step of “(1) Production of thermochromic layer,” a polyvinyl butyral resin (PVB2) (average degree of polymerization: 2,300, hydroxy group content: 22 mol %, degree of acetylation: 13 mol %, degree of butyralization: 65 mol %) was used instead of the polyvinyl butyral resin (PVB1), and that the resulting thermochromic layer was allowed to stand at constant temperature and humidity of a temperature of 23° C. and a humidity of 3% for a longer time than in Example 1.

### Comparative Example 1

### (1) Production of Interlayer Film for Laminated Glass

To 28 parts by mass of triethylene glycol di-2-ethylhexanoate (3GO) as a plasticizer were added 0.05 parts by mass of vanadium dioxide particles (average particle size: 77 μm, available from Shinko Chemical Co., Ltd), 0.5 parts by mass of polycarboxylic acid (AFB-0561, available from NOF Corporation) as a dispersant, and magnesium acetate as an adhesion adjuster in an amount that gives a magnesium acetate content of 50 ppm in the interlayer film for laminated glass to be obtained. The resulting mixture was mixed using a horizontal microbead mill. Thus, a vanadium dioxide particle dispersion was obtained. The vanadium dioxide particles in the dispersion had a volume average particle size of 132 nm.

The entire amount of the vanadium dioxide particle dispersion was added to 72 parts by mass of a polyvinyl butyral resin (PVB1). The resulting mixture was sufficiently melted and kneaded using a mixing roll. The kneaded product was sandwiched between polytetrafluoroethylene (PTFE) sheets. The resulting laminate was pressurized via a 760-μm-thick spacer using a hot press under conditions of 150° C. and 100 kg/cm² for 15 minutes, whereby an interlayer film for laminated glass with a thickness of 760 μm was obtained.

Thereafter, the obtained interlayer film for laminated glass was allowed to stand at constant temperature and humidity of a temperature of 23° C. and a humidity of 90% for 48 hours.

### (2) Production of Laminated Glass

A laminated glass was obtained in the same manner as in Example 1 except that the obtained interlayer film for laminated glass was used.

### Comparative Example 2

An interlayer film for laminated glass and a laminated glass were obtained in the same manner as in Example 1 except that, in the step of “(1) Production of thermochromic layer,” the obtained thermochromic layer was allowed to stand at constant temperature and humidity of a temperature of 23° C. and a humidity of 90%.

### Comparative Example 3

An interlayer film for laminated glass and a laminated glass were obtained in the same manner as in Example 4 except that, in the step of “(1) Production of thermochromic layer,” the obtained thermochromic layer was allowed to stand at constant temperature and humidity of a temperature of 23° C. and a humidity of 90%.

### Comparative Example 4

An interlayer film for laminated glass and a laminated glass were obtained in the same manner as in Example 2 except that, in the step of “(2) Production of first resin layer,” the obtained first resin layer was allowed to stand at constant temperature and humidity at a temperature of 23° C. and a humidity of 3% for a longer time than in Example 2, and that, in the step of “(3) Production of second resin layer,” the obtained second resin layer was allowed to stand at constant temperature and humidity of a temperature of 23° C. and humidity of 3% for a longer time than in Example 2.

### (Evaluation Methods)

The laminated glasses obtained above were evaluated as follows. The results are shown in Table 1.

### (1) Measurement of Water Content in Each Layer

During the production process in the examples and comparative examples, a specimen (10 g) was taken from each of the thermochromic layer, the first resin layer, and the second resin layer. Each specimen was allowed to stand in a lidded desiccator containing silica gel, and the lid was tightly closed. Subsequently, the desiccator was allowed to stand in a constant temperature room set at 23° C. The humidity in the desiccator was 1%. In this manner, the specimen was dried. The drying was continued until no weight change occurred. Thereafter, the weight of the specimen was measured. The measurement was performed at a temperature of 23° C. and a humidity of 30%. The time from the removal of the specimen from the desiccator to the measurement of the weight was 5 minutes. The water content of the thermochromic layer, the first resin layer, and the second resin layer was determined by the equation below. The water content thus determined is considered to be almost the same as that after these layers are laminated.

Water content (% by mass) of layer=[(weight of specimen before drying−weight of specimen after drying)×100]/(weight of specimen before drying)

### (2) Adhesiveness

### (Measurement of Pummel Value of Interlayer Film for

### Laminated Glass)

The obtained laminated glass was adjusted to a temperature of −18° C.±0.6° C. for 16 hours. The center portion (area of 150 mm in length×150 mm in width) of the laminated glass was hammered using a hammer with a head weight of 0.45 kg, so that the glass was pulverized to a glass particle size of 6 mm or less. The degree of exposure of the film after partial peeling of the glass was measured. The pummel value was then determined in conformity with Table 2. A greater pummel value indicates a greater adhesion of the interlayer film to glass. A smaller pummel value indicates a smaller adhesion of the interlayer film to glass.

(3) Measurement of Infrared Transmittance (Tir (780 to 2500 nm))

The infrared transmittance Tir at a wavelength of 780 to 2500 nm at 100° C. of the laminated glasses obtained in Examples 1 to 5 and Comparative Examples 1 to 3 was measured before a long-term stability test. The measurement was performed in conformity with JIS R 3106 (1998) with an UV-Vis-NIR spectrometer (“V-670,” available from JASCO Corp.) and a temperature control unit.

### (4) Long-Term Stability Test (High Humidity Test)

The laminated glasses obtained in Examples 1 to 5 and Comparative Examples 1 to 3 were stored in a constant temperature and humidity oven at 50° C. and a relative humidity of 95% for two weeks. Following this high humidity test, the infrared transmittance Tir was measured by the above-described method. From the measurements, ΔTir ((Tir after high humidity test)−(Tir before high humidity test)) was determined. A smaller ΔTir value indicates better long-term stability in the high humidity test.

TABLE 1

| | | | | | | | | | | Comparative | Comparative | Comparative | Comparative |
|---|---|---|---|---|---|---|---|---|---|---|---|---|---|
| | | | Example 1 | Example 2 | Example 3 | Example 4 | Example 5 | Example 6 | Example 7 | Example 1 | Example 2 | Example 3 | Example 4 |
| Thermochromic layer | Thermoplastic | Kind | PVB1 | PVB1 | PVB1 | PET | PET | PVB2 | PVB2 | PVB1 | PVB1 | PET | PVB1 |
| | resin | Amount | 72 | 72 | 72 | 100 | 100 | 72 | 72 | 72 | 72 | 100 | 72 |
| | | [parts by mass] | | | | | | | | | | | |
| | Vanadium | Kind | Vanadium | Vanadium | Vanadium | Vanadium | Vanadium | Vanadium | Vanadium | Vanadium | Vanadium | Vanadium | Vanadium |
| | dioxide | | dioxide | dioxide | dioxide | dioxide | dioxide | dioxide | dioxide | dioxide | dioxide | dioxide | dioxide |
| | particles | Amount | 0.05 | 0.05 | 0.05 | 0.05 | 0.05 | 0.05 | 0.05 | 0.05 | 0.05 | 0.05 | 0.05 |
| | | [parts by mass] | | | | | | | | | | | |
| | Plasticizer | Kind | 3GO | 3GO | 3GO | — | — | 3GO | 3GO | 3GO | 3GO | — | 3GO |
| | | Amount | 28 | 28 | 28 | — | — | 28 | 28 | 28 | 28 | — | 28 |
| | | [parts by mass] | | | | | | | | | | | |
| | Dispersant | Kind | Polycar- | Polycar- | Polycar- | — | — | Polycar- | Polycar- | Polycar- | Polycar- | — | Polycar- |
| | | | boxylic | boxylic | boxylic | | | boxylic | boxylic | boxylic | boxylic | | boxylic |
| | | | acid | acid | acid | | | acid | acid | acid | acid | | acid |
| | | Amount | 0.5 | 0.5 | 0.5 | — | — | 0.5 | 0.5 | 0.5 | 0.5 | — | 0.5 |
| | | [parts by mass] | | | | | | | | | | | |
| | Adhesion | Kind | — | — | — | — | — | — | — | Magnesium | — | — | — |
| | adjuster | | | | | | | | | acetate | | | |
| | | Mg content | — | — | — | — | — | — | — | 50 | — | — | — |
| | | [ppm] | | | | | | | | | | | |
| | Thickness [μm] | | 100 | 100 | 100 | 100 | 100 | 100 | 100 | 760 | 100 | 100 | 100 |
| | Water content | | 0.38 | 0.1 | 0.05 | 0.1 | 0.33 | 0.39 | 0.1 | 0.5 | 0.5 | 0.5 | 0.1 |
| | [% by mass] | | | | | | | | | | | | |
| First resin layer | Thermoplastic | Kind | PVB1 | PVB1 | PVB1 | PVB1 | PVB1 | PVB1 | PVB1 | — | PVB1 | PVB1 | PVB1 |
| | resin | Amount | 100 | 100 | 100 | 100 | 100 | 100 | 100 | — | 100 | 100 | 100 |
| | | [parts by mass] | | | | | | | | | | | |
| | Plasticizer | Kind | 3GO | 3GO | 3GO | 3GO | 3GO | 3GO | 3GO | — | 3GO | 3GO | 3GO |
| | | Amount | 40 | 40 | 40 | 40 | 40 | 40 | 40 | — | 40 | 40 | 40 |
| | | [parts by mass] | | | | | | | | | | | |
| | Adhesion | Kind | Magnesium | Magnesium | Magnesium | Magnesium | Magnesium | Magnesium | Magnesium | — | Magnesium | Magnesium | Magnesium |
| | adjuster | | acetate | acetate | acetate | acetate | acetate | acetate | acetate | | acetate | acetate | acetate |
| | | Mg content | 50 | 50 | 50 | 50 | 50 | 50 | 50 | — | 50 | 50 | 50 |
| | | [ppm] | | | | | | | | | | | |
| | Thickness [μm] | | 330 | 330 | 330 | 330 | 330 | 330 | 330 | — | 330 | 330 | 330 |
| | Water content | | 0.9 | 0.9 | 0.9 | 0.9 | 0.9 | 0.9 | 0.9 | — | 0.9 | 0.9 | 0.1 |
| | [% by mass] | | | | | | | | | | | | |
| Second resin layer | Thermoplastic | Kind | PVB1 | PVB1 | PVB1 | PVB1 | PVB1 | PVB1 | PVB1 | — | PVB1 | PVB1 | PVB1 |
| | resin | Amount | 100 | 100 | 100 | 100 | 100 | 100 | 100 | — | 100 | 100 | 100 |
| | | [parts by mass] | | | | | | | | | | | |
| | Plasticizer | Kind | 3GO | 3GO | 3GO | 3GO | 3GO | 3GO | 3GO | — | 3GO | 3GO | 3GO |
| | | Amount | 40 | 40 | 40 | 40 | 40 | 40 | 40 | — | 40 | 40 | 40 |
| | | [parts by mass] | | | | | | | | | | | |
| | Adhesion | Kind | Magnesium | Magnesium | Magnesium | Magnesium | Magnesium | Magnesium | Magnesium | — | Magnesium | Magnesium | Magnesium |
| | adjuster | | acetate | acetate | acetate | acetate | acetate | acetate | acetate | | acetate | acetate | acetate |
| | | Mg content | 50 | 50 | 50 | 50 | 50 | 50 | 50 | — | 50 | 50 | 50 |
| | | [ppm] | | | | | | | | | | | |
| | Thickness [μm] | | 330 | 330 | 330 | 330 | 330 | 330 | 330 | — | 330 | 330 | 330 |
| | Water content | | 0.9 | 0.9 | 0.9 | 0.9 | 0.9 | 0.9 | 0.9 | — | 0.9 | 0.9 | 0.1 |
| | [% by mass] | | | | | | | | | | | | |
| Evaluation | Adhesiveness | Pummel [−] | 4 | 3 | 3 | 3 | 4 | 4 | 3 | 4 | 4 | 3 | 8 |
| | Infrared | Before high | 61.1 | 61.1 | 61.3 | 60.2 | 62 | 61.6 | 60.8 | 61.2 | 61.2 | 59.3 | 62.3 |
| | transmittance | humidity test | | | | | | | | | | | |
| | [%] | (100° C.) | | | | | | | | | | | |
| | | After high | 64.6 | 64.2 | 63.4 | 63.3 | 64.9 | 64.8 | 63.4 | 72.5 | 70.1 | 69.5 | 64.3 |
| | | humidity test | | | | | | | | | | | |
| | | (100° C.) | | | | | | | | | | | |
| | | ΔTir | 3.5 | 3.1 | 2.1 | 3.1 | 2.9 | 32 | 2.6 | 11.3 | 8.9 | 102 | 2.0 |

TABLE 2

| Degree of exposure of interlayer film (area %) | Pummel value |
|---|---|
| 90 or greater and 100 or less | 0 |
| 85 or greater and less than 90 | 1 |
| 60 or greater and less than 85 | 2 |
| 40 or greater and less than 60 | 3 |
| 20 or greater and less than 40 | 4 |
| 10 or greater and less than 20 | 5 |
| 5 or greater and less than 10 | 6 |
| 2 or greater and less than 5 | 7 |
| less than 2 | 8 |

### INDUSTRIAL APPLICABILITY

The present invention provides an interlayer film for laminated glass that can maintain excellent thermochromic properties for a long period of time and have appropriate adhesiveness to laminated glass components, and also a laminated glass including the interlayer film for laminated glass.

### REFERENCE SIGNS LIST

1: Interlayer film for laminated glass
2: Thermochromic layer
2a: First surface
2b: Second surface
3: First resin layer
3a: Outer surface
4: Second resin layer
4a: Outer surface
5: Vanadium dioxide particles
11: Laminated glass
12: Laminated glass component
13: Laminated glass component

1. An interlayer film for laminated glass, the interlayer film comprising:
a first resin layer containing a thermoplastic resin;
a thermochromic layer; and
a second resin layer containing a thermoplastic resin,
the layers being laminated in the stated order in the thickness direction,
the thermochromic layer containing a thermoplastic resin and vanadium dioxide particles and having a water content of less than 0.4% by mass,
the first resin layer and the second resin layer each having a water content that is higher than the water content of the thermochromic layer.

2. The interlayer film for laminated glass according to claim 1,
wherein the thermoplastic resin contained in the thermochromic layer is a polyalkylene terephthalate resin.

3. The interlayer film for laminated glass according to claim 1,
wherein the thermoplastic resin contained in the thermochromic layer is a polyvinyl acetal resin.

4. The interlayer film for laminated glass according to claim 3,
wherein the polyvinyl acetal resin contained in the thermochromic layer has a hydroxy group content of 30 mol % or less and an acetyl group content of 5 mol % or more.

5. The interlayer film for laminated glass according to claim 1,
wherein the thermoplastic resin contained in the first resin layer and the second resin layer is a polyvinyl acetal resin.

6. A laminated glass comprising:
laminated glass components; and
the interlayer film for laminated glass according to claim 1 interposed between the laminated glass components.

7. The interlayer film for laminated glass according to claim 2,
wherein the thermoplastic resin contained in the first resin layer and the second resin layer is a polyvinyl acetal resin.

8. The interlayer film for laminated glass according to claim 3,
wherein the thermoplastic resin contained in the first resin layer and the second resin layer is a polyvinyl acetal resin.

9. The interlayer film for laminated glass according to claim 4,
wherein the thermoplastic resin contained in the first resin layer and the second resin layer is a polyvinyl acetal resin.

10. A laminated glass comprising:
laminated glass components; and
the interlayer film for laminated glass according to claim 2 interposed between the laminated glass components.

11. A laminated glass comprising:
laminated glass components; and
the interlayer film for laminated glass according to claim 3 interposed between the laminated glass components.

12. A laminated glass comprising:
laminated glass components; and
the interlayer film for laminated glass according to claim 4 interposed between the laminated glass components.

13. A laminated glass comprising:
laminated glass components; and
the interlayer film for laminated glass according to claim 5 interposed between the laminated glass components.
